(19) United States
(12) Patent Application Publication
(10) Pub. No.: US 2002/0184122 A1
(43) Pub. Date: Dec. 5, 2002

(54) Equipment rental-charge accounting system

(75) Inventors: Seiji Yamaguchi, Tokyo (JP); Katsuya Suzuki, Sagamihara-shi (JP); Shinichi Omori, Tokyo (JP); Masakazu Omoto, Tokyo (JP)

Correspondence Address: Paul J. Esatto, Jr., Scully, Scott, Murphy & Presser, 400 Garden City Plaza, Garden City, NY, 11530, US

(73) Assignee: OLYMPUS OPTICAL CO., LTD., TOKYO (JP)

(21) Appl. No.: 10/116,538

(22) Filed: Apr. 4, 2002

(30) Foreign Application Priority Data
Apr. 5, 2001 (JP) 2001-107529

(51) Int. Cl. G06F 17/60

(52) U.S. Cl. 705/30

(57) ABSTRACT

The present invention provides a system that allows a required number of pieces of equipment to be efficiently rented out in a desired plan and that enables a charge to be calculated based on the actual usage of the equipment. A set including a plurality of rental equipment of different rental plan is connected to a communication network via public lines or receivers. At least usage information is sent to a rental company, which is connected to the network, and the host computer of the rental company calculates the charge for the equipment based on this usage information.

This application claims benefit of Japanese Application No. 2001-107529 filed in Japan on Apr. 5, 2001, the contents of which are incorporated by this reference.

### BACKGROUND OF THE INVENTION

1. Field of the Invention

The present invention relates to an equipment rental-charge accounting system.

2. Description of the Related Art

With recent advances in medical equipment, a situation has arisen in which tests such as endoscopic tests and electrocardiograph tests are being conducted even in group health checkups.

However, for example, whereas the number of people being checked in an annual group health checkup can be extremely large, the person providing the medical care may only have the number of pieces of medical equipment required for normal use. Therefore, because of the limited number of pieces of medical equipment that can be used for a group health checkup, a substantial length of time is required to check everyone's health. This is not only a problem for the person providing the medical care but also for those undergoing the health checkup.

Conversely, reducing the diagnosis time in order to lighten the above burden impedes proper diagnosis.

One possible way of improving this situation is to borrow the required medical equipment from another provider but in reality, it is difficult to guarantee the required number of pieces of medical equipment.

### SUMMARY OF THE INVENTION

An object of the present invention is to provide an equipment rental-charge accounting system that efficiently is rented as much as the required number of pieces of equipment in the desired rental plan and that accounts charges for that equipment based on usage.

The equipment rental-charge accounting system according to the present invention comprises: equipment that implements a prescribed function; a work amount detection unit placed in the above equipment that detects the work done by that equipment; a work information output unit that outputs the above amount of work detected in the above work amount detection unit as the work information for the above equipment; a work information transmitter-receiver that is provided separately from the above equipment and that outputs work information output from the above work information output unit to a communication network; and a usage charge calculation unit that receives the above work information transmitted via the above communication network and calculates usage charge for the above equipment based on the prescribed payment conditions information for that equipment and the above work information.

Other characteristics and benefits of the present invention will be made sufficiently clear in the following explanations.

### BRIEF DESCRIPTION OF THE DRAWINGS

FIGS. 1 through 19 relate to an aspect of the embodiment of the present invention.

FIG. 1 is a first diagram showing the external configuration of endoscopic equipment;

FIG. 2 is a second diagram showing the external configuration of endoscopic equipment in FIG. 1;

FIG. 3 shows the configuration of the signal processing unit in FIG. 1;

FIG. 4 explains the quick-disconnect detection button in FIG. 3;

FIG. 5 shows the appearance of the transmitter-receiver that receives signals sent from the signal processing unit in FIG. 3;

FIG. 6 shows the configuration of the transmitter-receiver in FIG. 5;

FIG. 7 shows the appearance of a personal computer that receives signals sent from the signal processing unit in FIG. 3;

FIG. 8 is a first diagram explaining an example of diagnostic software operating in the personal computer of FIG. 7;

FIG. 9 is a second diagram explaining an operating example of diagnostic software in the personal computer of FIG. 7.

FIG. 10 is a third diagram explaining an operating example of diagnostic software in the personal computer of FIG. 7;

FIG. 11 shows a CD-ROM in which the diagnostic software of FIGS. 8 through 10 is stored;

FIG. 12 is a first diagram explaining a rental plan used for diagnosis by a visiting medical practitioner using the endoscope equipment of FIG. 1;

FIG. 13 is a second diagram explaining a rental plan used for diagnosis by a visiting medical practitioner using the endoscope equipment of FIG. 1;

FIG. 14 shows the connection between the rental company and the various rental plans in which the endoscope of FIG. 1 is used;

FIG. 15 shows the configuration of the leaser's system of FIG. 14;

FIG. 16 is a first flowchart explaining the actions of an equipment rental system for a rental plan in which the endoscope of FIG. 1 is used;

FIG. 17 is a second flowchart explaining the actions of an equipment rental system for a rental plan in which the endoscope of FIG. 1 is used;

FIG. 18 is a third flowchart explaining the actions of an equipment rental system for a rental plan in which the endoscope of FIG. 1 is used; and

FIG. 19 is a fourth flowchart explaining the actions of an equipment rental system for a rental plan in which the endoscope of FIG. 1 is used.

### DESCRIPTION OF THE PREFERRED EMBODIMENTS

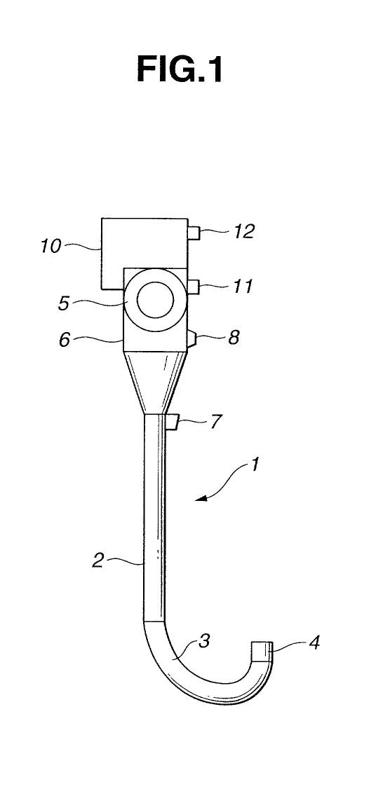

As shown in FIG. 1, in this aspect of the embodiment, endoscope 1, which comprises an endoscope unit that is a piece of medical equipment rented from a rental company, has a flexible, long and narrow insertion part 2. At the tip of insertion part 2 is a bending portion 3 and a tip 4. At the base of the insertion part 2 is an operation part 6, which is equipped with a curved knob 5 that causes the bending portion 3 to curve.

Although not shown, an image pickup element, for example a CCD, is built into the tip 4 of insertion part 2. A light guide is inserted from the base of the operation part 6 right up to the tip 4 of insertion part 2. Furthermore, a forceps channel is provided in insertion part 2. This is connected with forceps insertion mouth 7 provided at the base of the insertion part 2. Forceps and so on that are inserted through this forceps insertion mouth 7 protrude from the tip of the tip 4 and are used in various procedures.

There is also a water channel in the operation part 6 and insertion part 2. This is connected to a water-supply syringe connection part 8 provided in operation part 6. An objective optical system on the surface of the tip of the tip 4 can be washed by connecting the water-supply syringe connection part 8 and supplying water along the water channel.

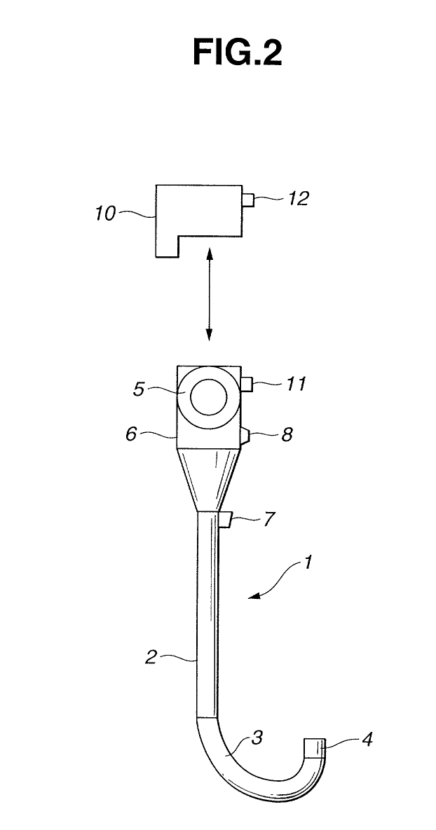

As shown in FIG. 2, a signal processing unit 10, which comprises the endoscope 1 and an endoscopic unit, supplies light for a light guide at the surface of the base of operation part 6. In addition, the signal processing unit 10, which drives a CCD and processes image signals, is detachably connected. Images can be recorded according to prompts from an image record prompt button 11 that is provided in operation part 6. There is also a power on a button 12 in this signal processing unit 10. Pressing of this power on the button 12 enables control of the power required for the supply of light and for signal processing.

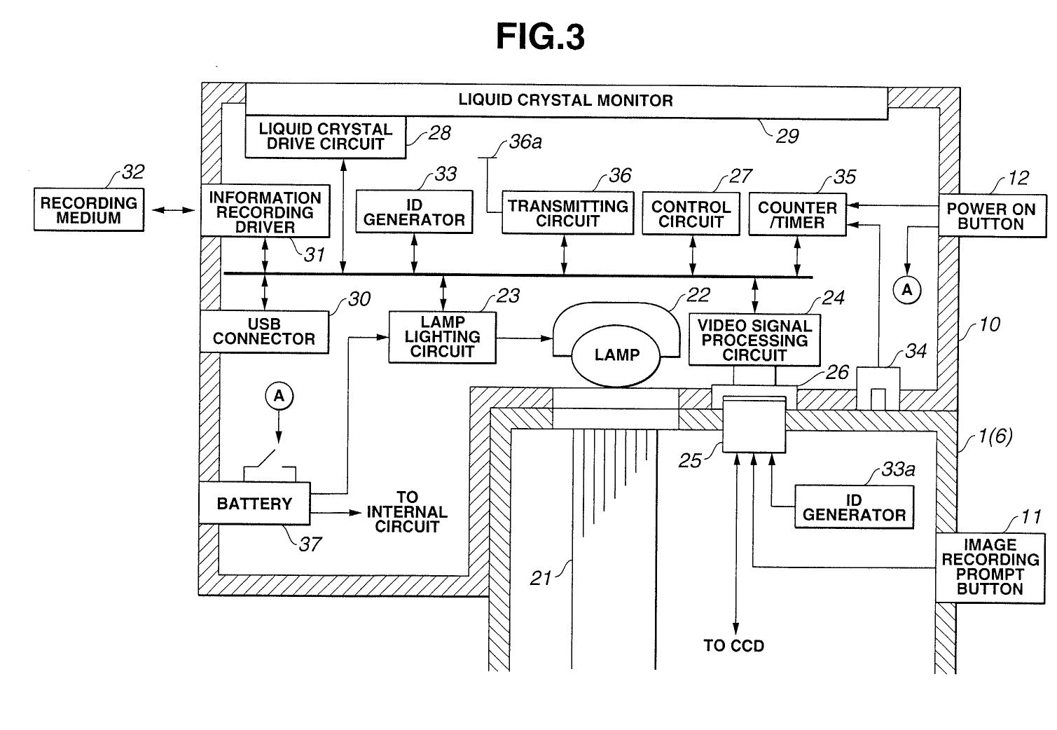

More specifically, as shown in FIG. 3, the signal processing unit 10 comprises: a lamp 22 that supplies light to a light guide 21 in the endoscope 1; a lamp lighting circuit 23 that lights the lamp 22; and a video signal processing circuit 24 that drives a CCD built into the tip of the endoscope 1 and processes image signals.

On the surface of the base of operation part 6 of the endoscope 1 is a connector 25 that connects an image recording prompt button 11 and the CCD signal line, which transmits CCD drive signals and image signals. The signal processing unit 10 also has a connector holder 26 that connects this connector 25.

When the connector 25 is connected to the connector holder 26 in the image signal processing circuit 24, the CCD built into the tip of the endoscope 1 is driven and the image signals are processed. Also, a record image prompt is received from the image record prompt button 11.

Also, when a liquid crystal drive circuit 28 is driven based on the video signals processed by video signal processing circuit 24, endoscopic images can be displayed on a liquid crystal monitor 29 provided on the outer surface of the signal processing unit 10. Furthermore, the signal processing unit 10 can transmit endoscopic images to a personal computer via a USB cable if a USB cable, which is not shown, is connected to the USB connector 30.

The signal processing unit 10 also has an information recording driver 31 that can be installed so that a recording medium 32 can be quickly disconnected. When the video signal processing circuit 24 receives a prompt to record an image from the image record prompt button 11, the signal processing unit 10 can, by driving the information recording driver 31, record image data onto recording medium 32 from video signals it has processed. Images are recorded onto the recording medium 32 in a prescribed format and a user can reproduce the image using a personal computer, for example.

All above circuits in the signal processing unit 10 are controlled by the control circuit 27.

Also, signal processing unit 10 includes an ID generator 33 that generates a signal processing unit ID that is information unique to the signal processing unit 10. A control circuit 27 can read this signal processing unit ID.

The operation part 6 of the endoscope 1 also contains an ID generator 33a that generates an endoscope ID, which is information unique to an endoscope 1. The control circuit 27 can read the endoscope ID via the connector 25, connector holder 26, and video signal processing circuit 24.

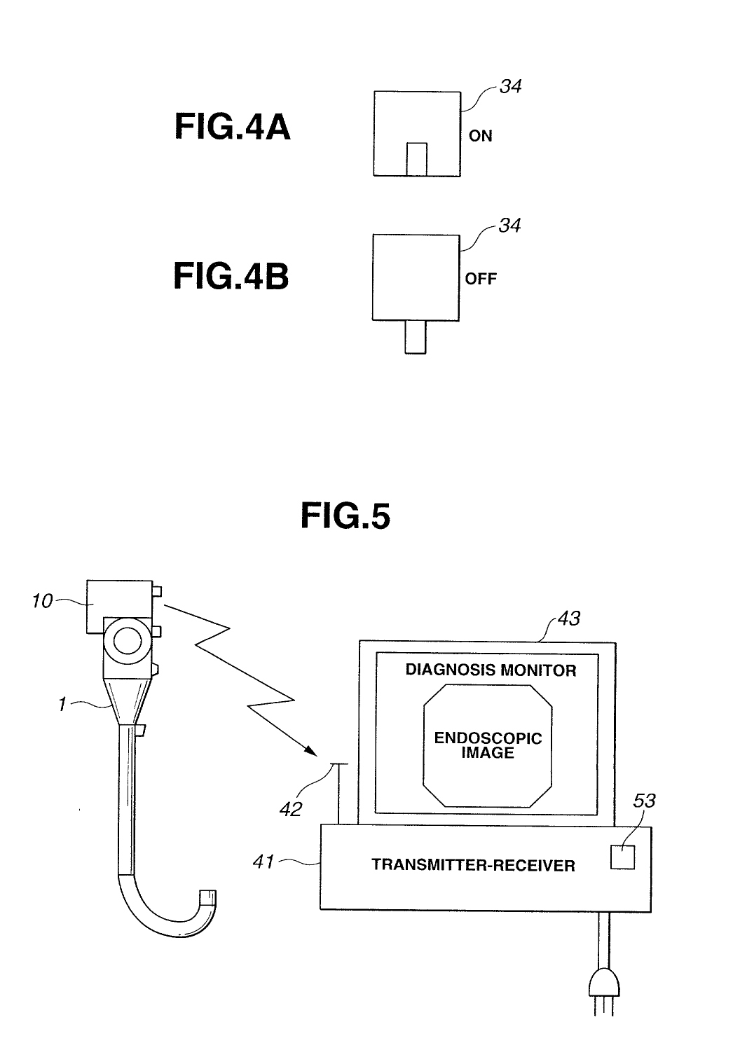

The signal processing unit 10 is further equipped with a quick-disconnect detection button 34 that detects quick disconnection of the endoscope 1. As shown in FIG. 4(a), when the endoscope 1 is attached to the signal processing unit 10 (refer to FIG. 1), the quick-disconnect detection button 34 is ON. When the endoscope 1 and signal processing unit 10 are separated (refer to FIG. 2), the quick-disconnect detection button 34 is OFF. Returning now to FIG. 3, this ON/OFF signal is input into a counter/timer circuit 35 shown in FIG. 3, and the number of times that the endoscope 1 is connected to the signal processing unit 10 is counted by the counter/timer circuit 35. In addition, the quick-disconnect status with the endoscope 1 is sent to control circuit 27.

Also, the control circuit 27 controls the lamp lighting circuit 23. The lamp 22 is not lit when the endoscope 1 and signal processing unit 10 are disconnected but is lit only when the endoscope 1 is attached to the signal processing unit 10. This prevents unnecessary power consumption.

The ON/OFF signal for power on button 12 is also input into the counter/timer circuit 35. The counter/timer circuit 35 counts the number of times the power is turned on and then calculates the usage time.

Furthermore, the signal processing unit 10 has a transmitting circuit 36. Using control by the control circuit 27, the transmitting circuit 36 adds the video signals processed by the video signal processing circuit 24 to the usage information (number of times the endoscope 1 connected, number of times power turned on, usage time, and endoscope ID) counted by counter/timer circuit 35 and converts them into a send signal. This can be sent to the outside by radio using antenna 36a.

Likewise, the video signals processed by the video signal processing circuit 24 and usage information (number of times the endoscope 1 connected, number of times power turned on, usage time, and endoscope ID) counted by the counter/timer circuit 35 can be transmitted to a personal computer via the USB cable by connecting a USB cable, not shown, to the USB connector 30.

In the signal processing unit 10, power to these internal circuits and to the lamp lighting circuit 23 is supplied by a charged battery 37, a power supply source. The power supply from the battery 37 is controlled by pressing the power on button 12.

By connecting a USB cable, not shown, to the USB connector 30, patient data relating to image data recorded on the recording medium 32 can be input from a personal computer, for example. Input of patient data enables patient data to be added to image data and recorded onto the recording medium 32.

The endoscope 1 and signal processing unit 10 are of watertight construction each having a waterproof cap on their exposed parts. This ensures that each can be washed and disinfected in a cleaning machine.

The above explanation assumes that a CCD is installed in the tip 4 of the endoscope 1. However, it is also possible to place the CCD in the signal processing unit 10 and to provide an image guide in the endoscope 1, thus enabling images to be taken using the CCD installed in the signal processing unit 10 by transmitting endoscopic images through the image guide to the base of the endoscope 1.

By attaching the signal processing unit 10 to the endoscope 1 in this way, endoscopic images can be observed on the liquid crystal monitor 29, and a plan of equipment rental that enables simple endoscopic diagnosis is achieved (hereinafter referred to as simple diagnosis).

Here, memory, not shown, that stores usage information (number of times the endoscope 1 connected, number of times power turned on, usage time, and endoscope ID) is provided in the control circuit 27. When equipment rented for simple diagnosis is returned, the rental company reads this usage information and determines a charge for the rental based on the usage information. A flat-sum payment system may also be used as the charge accounting method for the simple diagnosis equipment rental plan.

Also, as explained above, the signal processing unit 10 converts both video signals processed by the video signal processing circuit 24 using the transmitting circuit 36 and usage information (number of times the endoscope 1 connected, number of times power turned on, usage time, and endoscope ID) counted by the counter/timer circuit 35 and sends it to the outside by radio. Therefore, as shown in FIG. 5, a transmitter-receiver 41 rented from a rental company is installed outside and this transmission signal is received by an antenna 42. By isolating a video signal from the signal received to display an endoscopic image on a diagnostic monitor 43, a rental plan that allows endoscopic diagnosis is enabled (hereinafter referred to as wireless diagnosis).

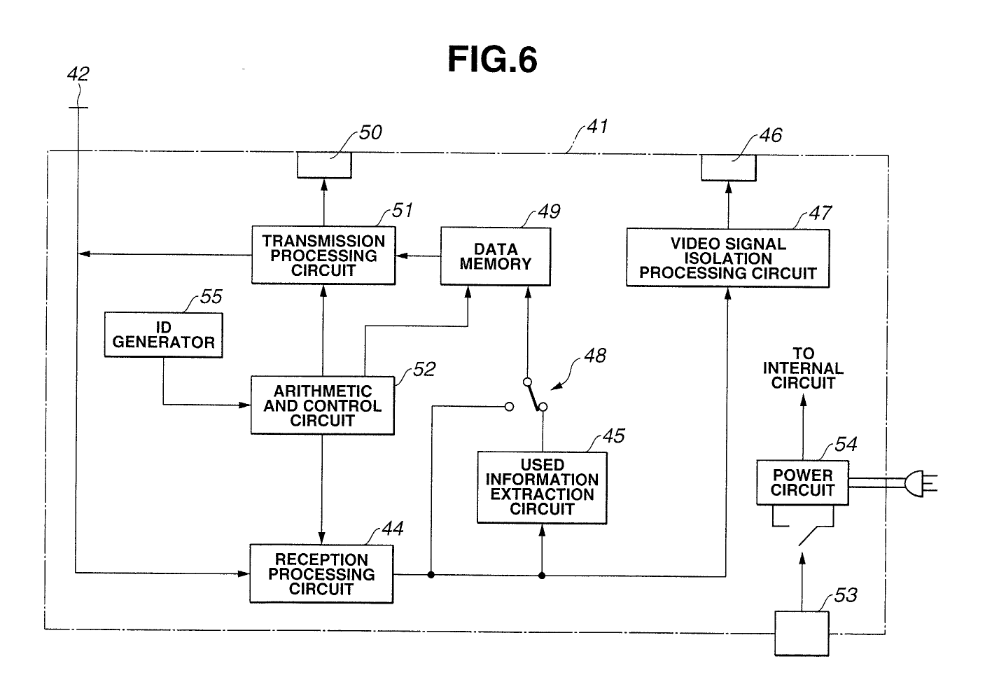

As shown in FIG. 6, transmitter-receiver 41 comprises: a reception processing circuit 44 that receives, via the antenna 42, signals sent from the transmitting circuit 36 in the signal processing unit 10 via an antenna 36a; a usage information extraction circuit 45 that extracts usage information from received information output from the reception processing circuit 44; a video signal isolation processing circuit 47 that isolates video information from received information output from the reception processing circuit 44 and outputs, for example, a standard TV signal via an output connector 46 to the diagnostic monitor 43; a data memory 49 that inputs, via a switch 48, signals for received information output from the reception processing circuit 44 or the usage information extracted using the usage information extraction circuit 45; a transmission processing circuit 51 that outputs information stored in the data memory 49 to public lines via a connector 50 or that converts this information into transmission signals (communication protocol for mobile telephones or PHS) and then outputs these to the outside via the antenna 42; an arithmetic and control circuit 52 that controls these circuits; a power circuit 54 that supplies power to all internal circuits when a power button 53 is pressed; and an ID generator 55 that generates a transmitter-receiver ID that is information unique to a transmitter-receiver 41.

Here, information output using public lines or radio is transmitted to the server of a rental company using a communication network connected to the public lines or a receiver. The rental company will set a charge based on image information and usage information

The switch 48 is set by a rental company based on a contract between the rental company and a user. In other words, when a user requests that the rental company save image data, the rental company must reserve space in the server for saving that image data. Therefore, the rental company charges the user in accordance with the storage capacity required.

Therefore, after the establishment of a such a contract for storage capacity and upon transportation of the equipment, the rental company sets the switch 48 to output, to the data memory 49, received information (image information and usage information) output from the reception processing circuit 44.

When a contract to reserve capacity is not established, upon transportation of the equipment the rental company sets the switch 48 to output, to the data memory 49, usage information extracted by the usage information extraction circuit 45.

It is not always necessary to rent out the diagnostic monitor 43 in this wireless diagnosis equipment rental plan. In other words for example, a user may observe endoscopic images on the liquid crystal monitor 29 and use the transmitter-receiver 41 to output to public lines information stored in the data memory 49 via the connector 50, or to convert the information to a transmission signal (communication protocol for mobile telephones or PHS) and output it to the outside via the antenna 42.

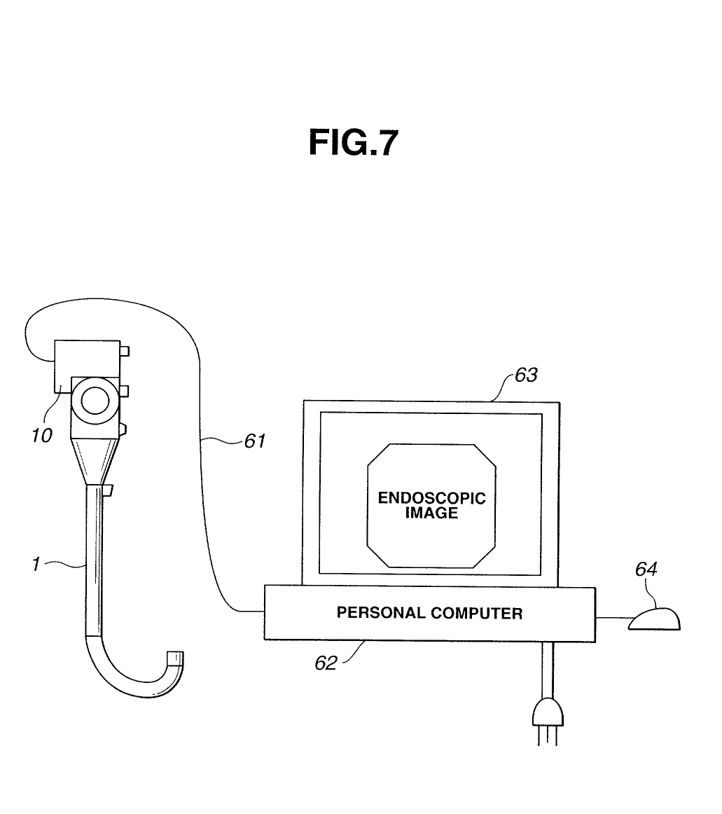

As explained above, video signals processed by the video signal processing circuit 24 and usage information (number of times the endoscope 1 connected, number of times power turned on, usage time, and endoscope ID) counted by the counter/timer circuit 35 can be transmitted to a personal computer via a USB cable when a USB cable, not shown, is connected to the USB connector 30. Therefore, as shown in FIG. 7, a personal computer 62 rented out from a rental company is set up so that it is connected to the USB connector 30 on the signal processing unit 10 using a USB cable 61. Video signals are isolated, using the personal computer 62, from the signal received via the USB cable 61 and endoscopic images are displayed on a monitor 63. This enables an equipment rental plan for endoscopic diagnosis (hereinafter referred to as a personal computer diagnosis).

In this rental plan of a personal computer diagnosis equipment, the personal computer 62 uses a telephone line, or mobile or PHS function built in the personal computer 62 and either wired or radio means to output video signals and usage information gathered by the signal processing unit 10. The output information is then transmitted to the server of the rental company via a communication network to which a receiver is connected or via public lines. The rental company then determines a charge based on the image information and usage information.

It is also possible to use diagnostic software rented from a rental company to set, on the personal computer 62, the information output as video signals and usage information or usage information only, using a telephone line as wired means or mobile or PHS function as radio means provided in personal computer 62.

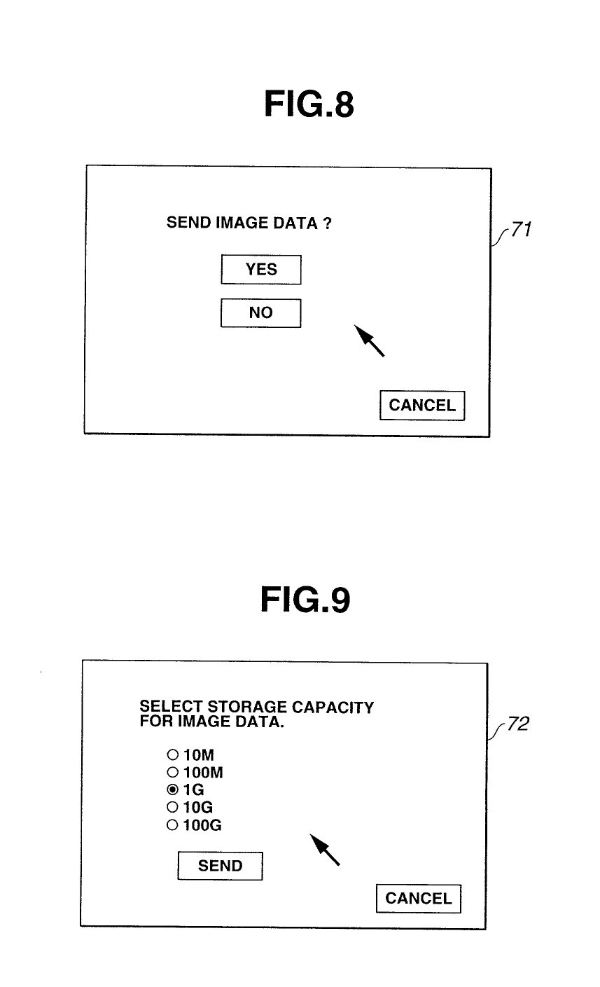

In other words, by starting diagnostic software and operating a mouse 64, the set image data transmission screen 71, on which the transmission of image data as shown in FIG. 8 is set, is called up. Here, if the selection requests that image data is not sent, only usage information will be sent.

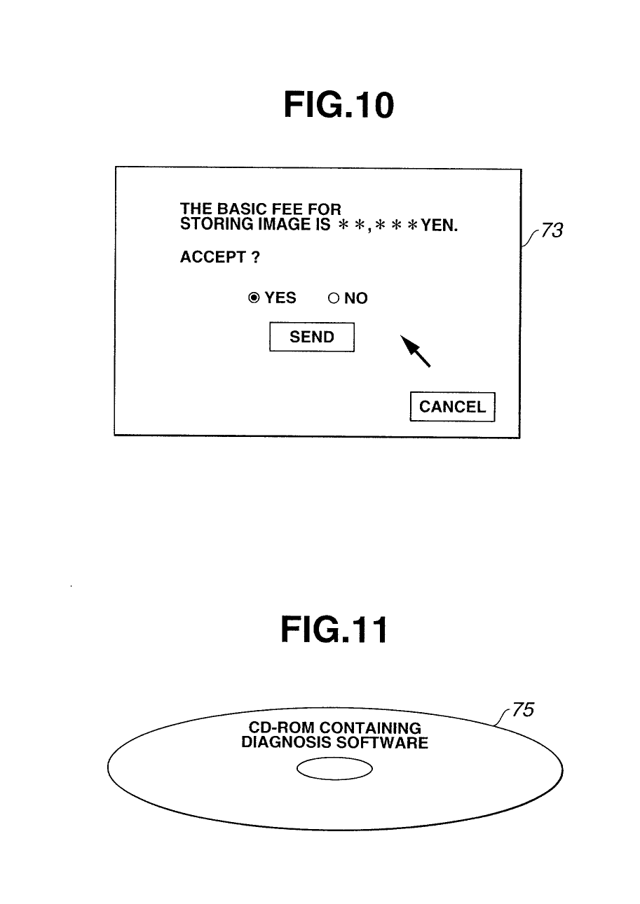

Also, if the selection on the set image data transmission screen 71 requests that image data is sent, a set storage capacity screen 72, on which the desired capacity for storing image data is set as shown in FIG. 9, is displayed. When the desired capacity is set on the set storage capacity screen 72, a cost confirmation screen 73 as shown in FIG. 10 that displays the costs required for the storage capacity, is displayed. Upon sending acceptance of the fee, video signals and usage information are sent.

In a personal computer diagnosis equipment rental plan, the user may use their own personal computer rather than one rented from a rental company, and rent an endoscope 1, a signal processing unit 10, and a CD-ROM 75 that stores the diagnostic software such as that shown in FIG. 11, to establish the personal computer diagnostic rental plan.

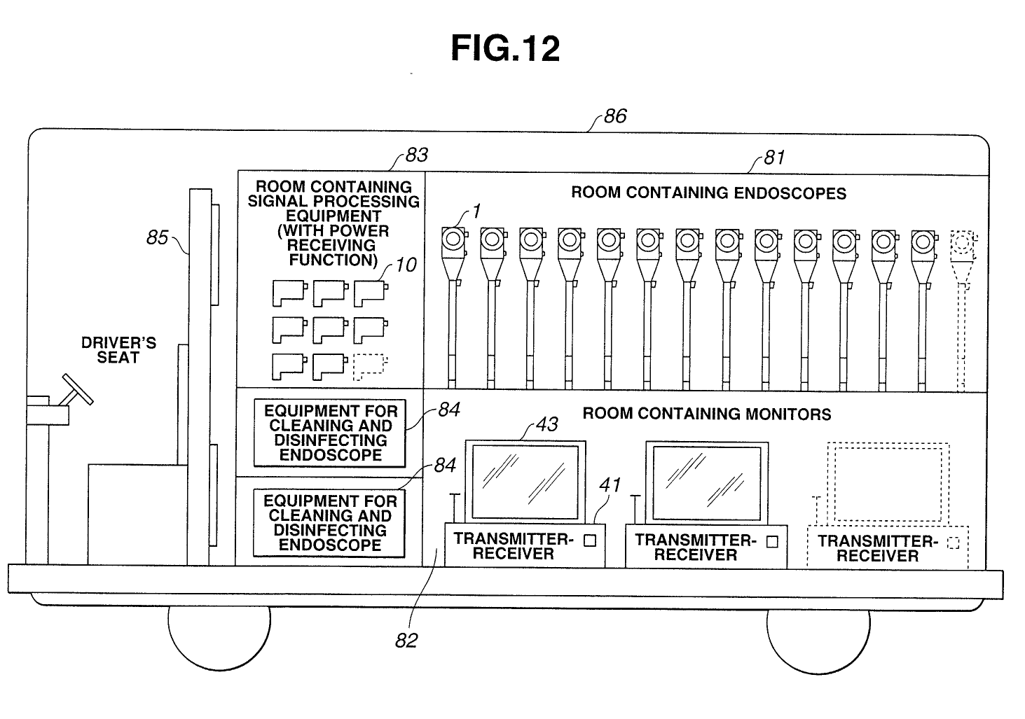

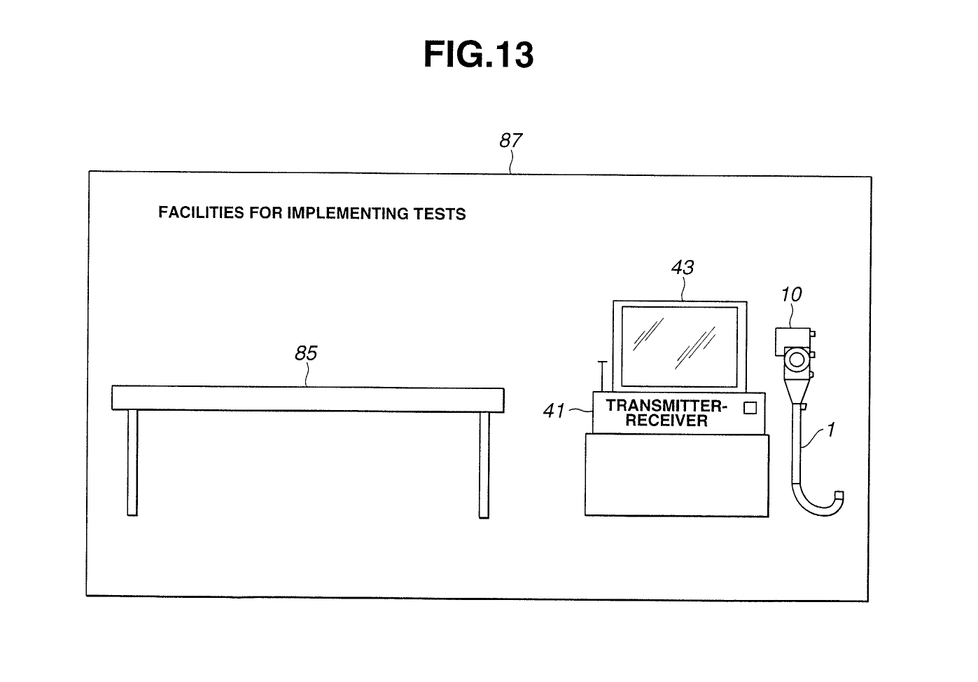

Next, visiting diagnosis, a rental plan suitable to regular group checkups made by a visiting medical practitioner, will be explained. As shown in FIG. 12, the visiting diagnosis rental plan comprises: an endoscope room 81 that houses a multiplicity of endoscopes 1; a monitor room 82 that houses a multiplicity of transmitter-receivers 41 and diagnostic monitors 43; a signal processing unit room 83 that houses a multiplicity of signal processing units 10; a multiplicity of endoscope cleaners 84 that wash and disinfect used endoscopes 1 and signal processing units 10; and an endoscope diagnosis vehicle 86 that contains a diagnosis bed 85 on which a patient can lie for diagnosis. As shown in Fig. 13, an institution implementing checkups 87 has the diagnosis bed 85, transmitter-receiver 41, diagnosis monitor 43, endoscope 1, and signal processing unit 10 and implements regular group checkups.

Thus, the service provided by the rental company enables various rental plans and even in these rental plans, the configuration of the equipment being rented out varies. Therefore, sets of various rental equipment, to suit the various rental plans, are shown in Table 1.

TABLE 1

| | Main | Signal | | | | | Endoscopic |
|---|---|---|---|---|---|---|---|
| | endoscope | processing | Transmitter- | Diagnostic | Diagnostic | Personal | diagnosis |
| | unit | unit | receiver | monitor | software | computer | vehicle |
| Set A (simple diagnosis | ◯ | ◯ | | | | | |
| set) | | | | | | | |
| Set B1 (wireless | ◯ | ◯ | ◯ | | | | |
| diagnosis set) without | | | | | | | |
| monitor | | | | | | | |
| Set B2 (wireless | ◯ | ◯ | ◯ | ◯ | | | |
| diagnosis set) with | | | | | | | |
| monitor | | | | | | | |
| Set C1 (personal computer | ◯ | ◯ | | | ◯ | | |
| diagnosis set) without | | | | | | | |
| monitor | | | | | | | |
| Set C2 (personal computer | ◯ | ◯ | | | ◯ | ◯ | |
| diagnosis set) with | | | | | | | |
| monitor | | | | | | | |
| Set D (regular group | ◯ | ◯ | ◯ | ◯ | | | ◯ |
| checkup set) | | | | | | | |

That is, Set A is for simple diagnosis rental, Set B1 is for wireless diagnosis rental without a monitor, Set B2 is for wireless diagnosis rental with a monitor, Set C1 is for personal computer diagnosis rental without a monitor, Set C2 is for personal computer diagnosis rental with a monitor, and Set D is for visiting diagnosis rental.

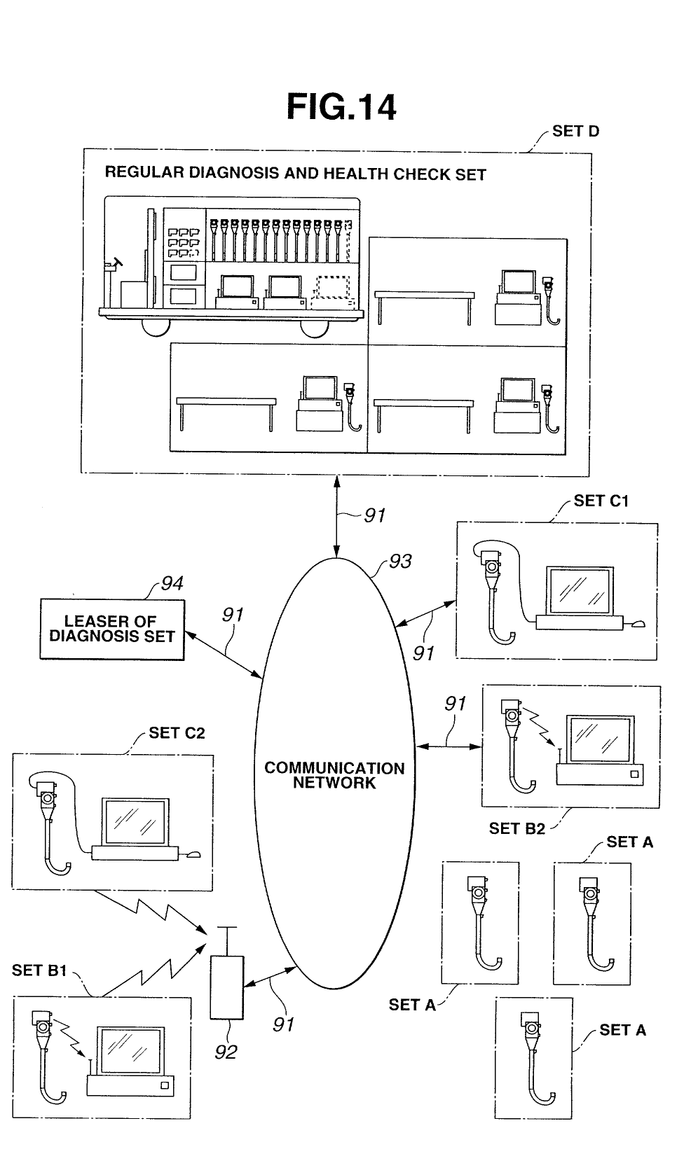

As shown in FIG. 14, except for Set A, these sets are connected to a communication network 93 via public lines 91 or a receiver 92. Video signals and usage information, or usage information only, is transmitted to a rental company 94 connected to the communication network 93.

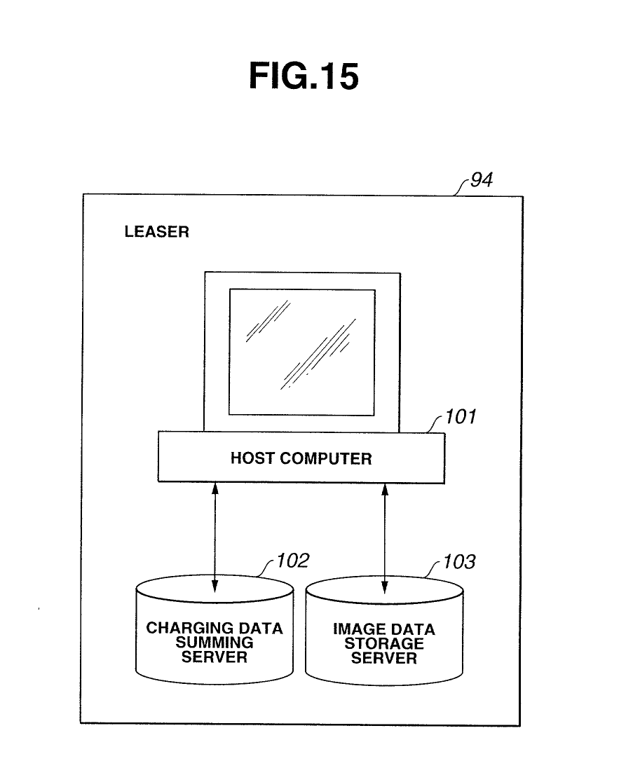

As shown in FIG. 15, the rental company 94 comprises a host computer 101 that calculates and manages data; a charging data summing server 102 in which the host computer 101 stores calculated charges based on usage information; and an image data storage server 103 that stores image data.

The operation of an aspect of the embodiment configured as such will be explained using an example of a Set B2 rental plans.

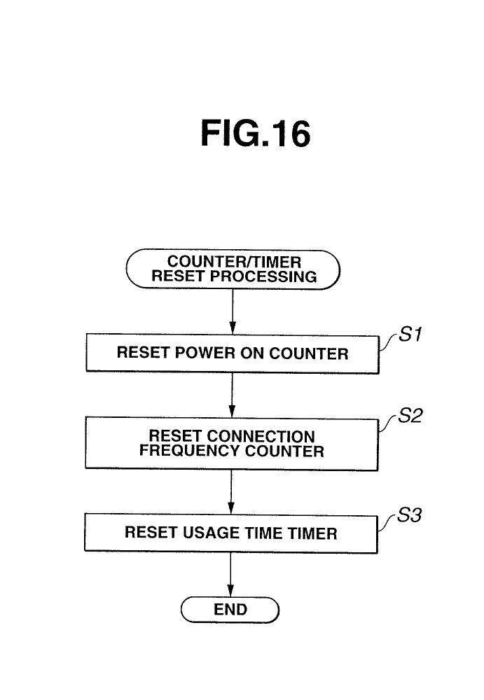

When the rental company 94 establishes a rental contract with the user, the rental company 94 performs resetting operations on the signal processing unit 10 to rent. Namely, as shown in FIG. 16, the rental company 94 resets the power on counter in the counter-timer circuit 35 in the signal processing unit 10 in Step S1, the rental company 94 resets a connection frequency counter in the counter/timer circuit 35 in Step S2, and resets a usage time timer in the counter/timer circuit 35 in Step S3.

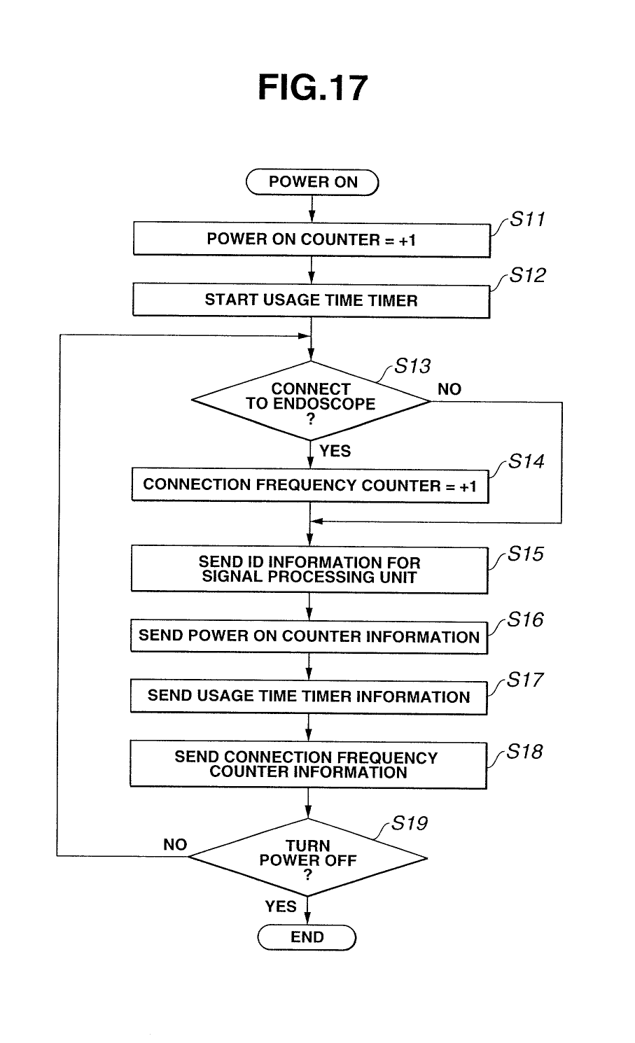

When the counter/timer circuit 35 has been thus reset, the signal processing unit 10 is rented to the user. At the user's site, as shown in FIG. 17, when the power on button 12 for the signal processing unit 10 is pressed, the power on counter in the counter/timer circuit 35 of the signal processing unit 10 is incremented in Step S11, and in Step S12, counting in a usage time timer of the counter/timer circuit 35 starts.

In Step S13, a judgement as to whether or not the endoscope 1 is connected, is made by the control circuit 27 using the quick-disconnect detection button 34. If the signal processing unit 10 is deemed to be connected to the endoscope 1, in Step S14, the control circuit 27 increments a connection frequency counter in the counter/timer circuit 35. Processing then proceeds to Step S15. Processing proceeds directly to Step S15 when the signal processing unit is deemed not to be connected to endoscope 1.

Next, in Step S15, the control circuit 27 acquires a signal processing unit ID from the ID generator 33 and sends it from the transmitting circuit 36 to the transmitter-receiver 41.

The control circuit 27 then, in Step S16, sends power on counter information to the transmitter-receiver 41 from the transmitting circuit 36. In Step S17, it sends usage time timer information to the transmitter-receiver 41 from the transmitting circuit 36. In Step S18, it sends connection frequency counter information to the transmitter-receiver 41 from the transmitting circuit 36. In Step S19, it determines whether or not the power on button is off, ending processing if it is off and returning to Step S13 to repeat processing if it is still on.

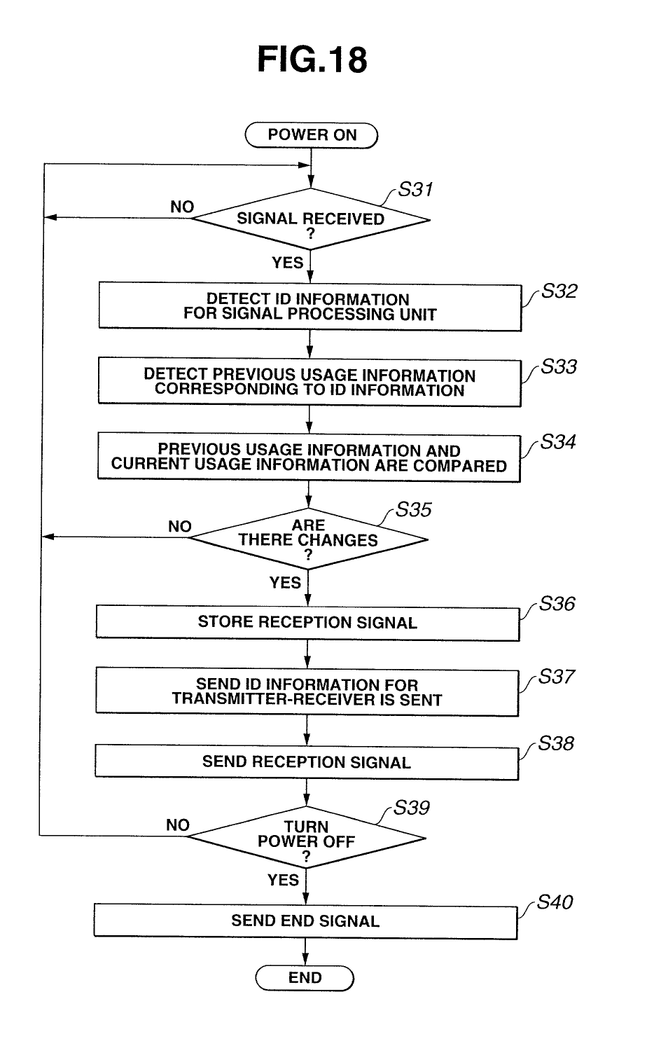

In contrast, when the power button 53 is pressed, as shown in FIG. 18, in Step S31, the arithmetic and control circuit 52 in the transmitter-receiver 41 awaits reception of information from the signal processing unit 10. When it receives information from the signal processing unit 10, the arithmetic and control circuit 52, in Step S32, detects a signal processing unit ID from the received signal. In Step S33, it reads the previous counter information (usage information: power-on input counter information, usage time timer information, connection frequency counter information) corresponding to the signal processing unit ID which is stored in the data memory 49. In Step S34, the current counter information (usage information: power-on input counter information, usage time timer information, connection frequency counter information) is detected from the received signal and compared to the previous counter information (usage information).

In Step S35, the arithmetic and control circuit 52 determines whether or not there have been changes in the current counter information (usage information) since the previous counter information (usage information). If there have been no changes, processing returns to Step S31. If there are changes, in Step S36, received information received from the signal processing unit 10 is recorded in the data memory 49 in conjunction with the signal processing unit ID.

Next, in Step S37, the arithmetic and control circuit 52 acquires a transmitter-receiver ID from the ID generator 55. It then sends the transmitter-receiver ID using communication lines or radio to the host computer 101 of the rental company 94. In Step S38, the arithmetic and control circuit 52 uses communication lines or radio to send received information stored in the data memory 49 to the host computer 101 of the rental company 94.

Next, in Step S39, the arithmetic and control circuit 52 determines whether or not the power button 53 is off. It returns to Step S31 if the power button 53 is on. If the power button 53 is off, in Step S40, the arithmetic and control circuit 52 uses communication lines or radio to send an end signal to the host computer 101 of the rental company 94 to end processing.

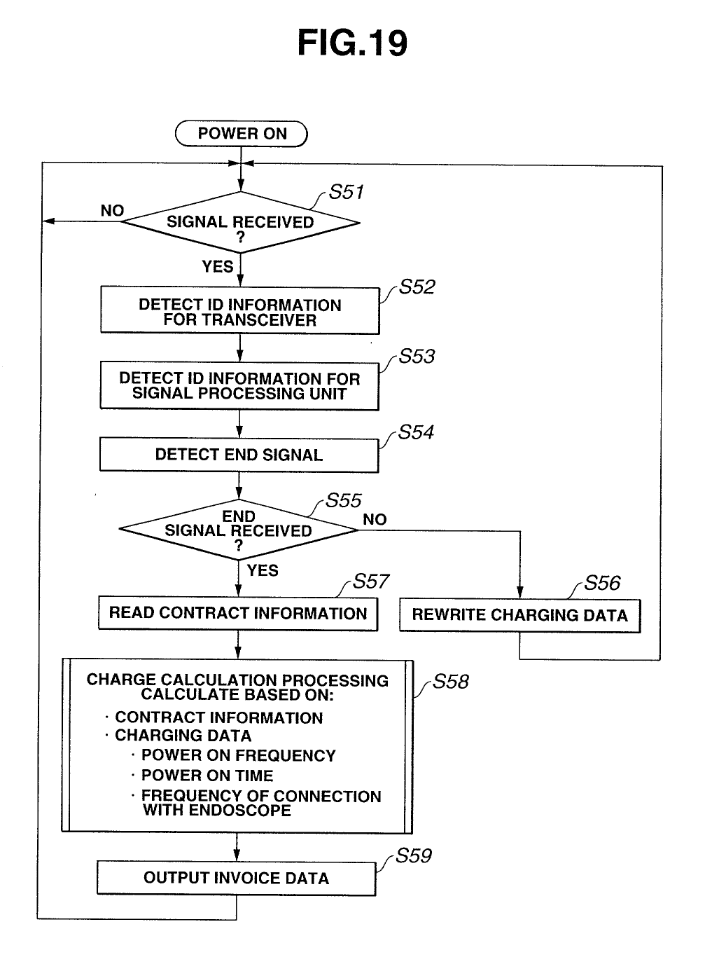

As shown in FIG. 19, in Step S51, the host computer 101 of rental company 94 awaits reception of information from the transmitter-receiver 41. When information is received from the transmitter-receiver 41, the host computer 101 detects the transmitter-receiver ID from the received signal in Step S52 then, in Step S53, detects a signal processing unit ID from the received signal and, in Step S54, detects an end signal.

Next, in Step S55, the host computer 101 determines whether or not the end signal has been received. If the end signal has not been received, in Step S56 the host computer 101 makes the charging data stored in the charging data summing server 102 correspond to signal processing unit ID based on counter information (usage information) in the received signal. It then returns processing to Step S51. When an end signal has been received, in Step S57, the host computer 101 reads contract information from the charging data summing server 102 based on the signal processing unit ID.

In Step S58, the host computer 101 calculates the charge from the charging data based on counter information (usage information: power-on input counter information, usage time timer information, connection frequency counter information). That is, it calculates the invoice amount.

In this charge (invoice amount) calculation, for example, long term contract discounts or new equipment trial period discounts are taken into consideration. A new equipment trial period discount refers to a system of discounting the cost of renting newly released equipment below that of renting old equipment. This is a service designed to effectively incorporate new models into the market.

When the charge (invoice amount) is calculated, in Step S59 the host computer 101 prints out the invoice data on a printer, not shown, then returns to Step S51.

When the host computer 101 enters into a contract to store image data on the image data storage server 103, charges are calculated according to the contracted storage capacity.

In such an aspect of the embodiment, a multiplicity of sets to suit different rental plans are connected to the communication network 93 via public lines 91 or the receiver 92. Usage information at least is transmitted to the rental company 94 connected to the communication network 93 and the host computer 101 of the rental company 94 calculates the charge for the equipment based on the usage information. Therefore, a rental company can efficiently rent out the number of pieces of equipment required in the desired rental plan and can charge for the equipment based on usage information.

The explanations above have covered endoscopes as an example of the rented medical equipment. However, the equipment is not limited to endoscopes. When any pieces of medical equipment are required in large quantities for short periods for group health checkups, for example, electrocardiographs, the ID information for the equipment is sent with the aforementioned counter information (usage information) to the host computer 101 of the rental company 94. The rental company achieves similar results by charging for the rental based on this information.

The present invention is also not limited to use with medical equipment. For example, the rental equipment involved could be personal computers, printer, and digital video equipment used when a multiplicity of course takers, for example in an Internet course, require them for study over a short period of time. As above, the ID information for the equipment is sent with the aforementioned counter information (usage information) to the host computer 101 of the rental company 94. The rental company achieves similar results by charging for the rental based on this information.

A wide range of different embodiments for the present invention can be configured without deviating from the spirit and scope of the present invention. Except where limited by the appended claims, the present invention is not restricted by any specified embodiments.

What is claimed is:

1. An equipment rental-charge accounting system, comprising:
equipment that implements a prescribed function;
a work amount detection unit that is located in said equipment and that detects an amount of work done by said equipment;
a work information output unit that outputs said amount of work detected by said work amount detection unit as work information of said equipment;
a work information transmitter-receiver that is provided separately from said equipment and that outputs work information output from said work information output unit to a communication network; and
a usage charge calculation unit that receives said work information transmitted via said communication network and that calculates usage charge for said equipment based on prescribed charge payment conditions information for said equipment and said work information.

2. A medical equipment system, comprising:
medical equipment used for implementing medical procedures upon a subject;
a work amount detection unit that is located in said medical equipment and that detects an amount of work done by said medical equipment;
a work information output unit that outputs said amount of work detected in said work amount detection unit as work information of said medical equipment; and
a work information transmitter-receiver that is provided separately from said medical equipment and that outputs work information output from said work information output unit to a communication network.

3. The medical equipment system according to claim 2, further comprising a usage charge calculation unit that receives said work information transmitted via said communication network and that calculates usage charge information for said medical equipment based on prescribed charge payment conditions information for said medical equipment and said work information.

4. A medical equipment system, comprising:
first medical equipment used to implement medical procedures on a subject;
a first work amount detection unit that is located in said first medical equipment and that detects an amount of work of said first medical equipment;
a first work information output unit that outputs first work information, which shows the amount of work detected by said first work amount detection unit, in conjunction with first identification information corresponding to said first medical equipment;
second medical equipment used to implement medical procedures on a subject;
a second work amount detection unit that is located in said second medical equipment and that detects an amount of work of said second medical equipment;
a second work information output unit that outputs second work information, which shows the amount of work detected by said second work amount detection unit, in conjunction with second identification information corresponding to said second said medical equipment;
a work information transmitter-receiver that is provided separately from said first and second medical equipment and that receives, while distinguishing, work information output from said first work information output unit and work information output from said second work information output unit, and outputs the work information to a communication network after providing with third identification information; and
a usage charge calculation unit that receives said work information transmitted via said communication network, detects charge payment conditions information corresponding to said third identification information, and calculates usage charge information for said first and second medical equipment based on the charge payment conditions thus detected and said work information.

5. A medical equipment usage charge calculation method comprising:
a work amount detection step of detecting an amount of work done by medical equipment used for the implementation of medical procedures on a subject;
a work information output step of outputting as work information said amount of work detected in said work amount detection step;
a work information reception/transmission step of receiving work information output in said work information output step using a work information transmitter-receiver that is provided separately from said medical equipment, and outputting this work information to a communication network; and
a usage charge calculation step of receiving said work information transmitted via said communication network and. calculating usage charge information for said medical equipment based on prescribed charge payment conditions information for said medical equipment and said work information.

6. A medical equipment work amount calculation program, comprising:
a first step that receives, from a communication network, identification information for a work information transmitting unit that transmits work information showing the amount of work done by medical equipment used to implement medical procedures on a subject;
a second step that receives, from said communication network, said work information transmitted by said work information transmitting unit;
a third step that detects, from said identification information, prescribed charge payment information for said work information transmitting unit; and
a fourth step that calculates usage charge information for said medical equipment based on said work information and said charge payment information.

7. A medical equipment rental charge adapter, comprising:
a connection part that is connected to medical equipment used for implementing medical procedures on a subject;
a work amount detection unit that detects an amount of work done by said medical equipment; and
a work information output unit that outputs, as work information for said medical equipment, said amount of work detected by said work amount detection unit.

8. An equipment rental charge adapter, comprising:
a connection part that is connected to equipment used to implement a prescribed function;
a work amount detection unit that detects the amount of work done by said equipment; and
a work information output unit that outputs, as work information for said equipment, said amount of work detected by said work amount detection unit.

9. A readable recording medium on which a medical equipment usage charge calculation program has been recorded, comprising:
a first step that receives, from a communication network, identification information for a work information transmitting unit that sends work information showing the amount of work done by medical equipment used for implementing medical procedures on a subject;
a second step that receives, from said communication network, said work information transmitted by said work information transmitting unit;
a third step that detects, from said identification information, prescribed charge payment information for said work information transmitting unit; and
a step for calculating usage charge information for said medical equipment based on said work information and said charge payment information.

10. An equipment rental system, comprising:
a data detection unit that detects, from data transmitted via a communication network, work information for contracted equipment being used by the transmitting party that transmitted the data and identification data for identifying said transmitting party;
a calculation unit that calculates and manages usage charge for said rental equipment from said work information in accordance with said identification data; and
a charging data summing and storing unit that stores the charge calculated by said calculation unit based on said work information.
